(19) United States
(12) Patent Application Publication
(10) Pub. No.: US 2016/0041522 A1
(43) Pub. Date: Feb. 11, 2016

(54) DISPLAY DEVICE FOR HOLOGRAPHIC IMAGES FOR SMALL AND MEDIUM SIZED MEDIA DEVICES

(71) Applicants: Arthur de Franceschi BRASIL, Porto Alegre (BR); Paulo Ricardo MASIERO, Porto Alegre (BR); José Rodolfo MASIERO, Porto Alegre (BR)

(72) Inventors: Arthur de Franceschi BRASIL, Porto Alegre (BR); Paulo Ricardo MASIERO, Porto Alegre (BR); José Rodolfo MASIERO, Porto Alegre (BR)

(21) Appl. No.: 14/919,835

(22) Filed: Oct. 22, 2015

Related U.S. Application Data
(63) Continuation of application No. PCT/BR2014/000236, filed on Jul. 11, 2014.

(30) Foreign Application Priority Data
Nov. 1, 2013 (BR) BR2020130282494

(51) Int. Cl. G03H 1/02; G03H 1/00; G02B 5/32

(52) U.S. Cl. CPC G03H 1/02; G02B 5/32; G03H 1/0005; G03H 2001/0232; G03H 2227/02; G03H 2001/0088

(57) ABSTRACT

A holographic image viewer for small and medium-sized media devices whose inventive concept lies in its portability, providing viewing of holographic moving images (the 3-D ones according to the incidence of light on the image) generated by any type of video player such as a smartphone, tablet, notebook, LED and LCD monitor. It provides complementary protection for these mobile devices and, as the main property of said device is its portability, it can be used individually and relies on low cost manufacturing technology.

### CROSS-REFERENCE TO RELATED APPLICATIONS

This Application is a CONTINUATION application claiming the benefit of priority of the co-pending International Patent Application No. PCT/BR2014/000236 with an international filing date 11 Jul. 2014 that designated the United States, which claims the benefit of priority of Federal Republic of Brazil Application No. BR2020130282494, filed 1 Nov. 2013, the entire disclosures of each (and all) of which Applications are expressly incorporated by reference in their entirety herein.

### BACKGROUND OF THE INVENTION

1. Field of the Invention

This utility model relates to a holographic image viewer for small and medium-sized media devices whose inventive concept lies in its portability, providing viewing of holographic moving images (the 3-D ones according to the incidence of light on the image) generated by any type of video player such as a smartphone, tablet, notebook, LED and LCD monitor. As the main property of said device is its portability, it can be used individually and relies on low cost manufacturing technology.

2. Prior Art

Techniques and devices for viewing holographic images, which have different peculiar characteristics, are already well-known in the art. As for the subject matter of this utility model, when an image is created, presented or recorded in two dimensions so as to provide an illusion of three dimensions, it is called “holography”, but it is not only one more simple way of viewing it in three dimensions, but a process of encoding information and fully recreating the very same information.

In the field of communications, holography is used as a powerful visual display which has been commercially used as a promotional element. While in the visual arts, artists use it as a form of expression. As for its reproduction, some devices developed for this kind of activity are already available on the market.

While still on the subject of the technique used in the field of communications, it was called “Pepper's Ghost” after John Henry Pepper who popularized it in the 16^{th} century, which was an illusion technique used in theater and in some magic tricks. By using plates of glass and special lighting techniques, objects were made to appear and disappear, become transparent or transform into other objects. Nowadays, this technique is popularized by use of television sets and projectors in combination with sheets of different materials such as glass, acrylic, etc.

A search conducted in the database of the National Institute of Industrial Property showed that there are some patent applications for this purpose as follows:

A patent application PI0517159-8 filed on Dec. 22, 2005 discloses a method for computing a hologram by determining the wavefronts at the approximate observer eye position that would be generated by a real version of an object to be reconstructed. In normal computer generated holograms, one determines the wavefronts needed to reconstruct an object; this is not done directly in the present invention. Instead, one determines the wavefronts at an observer window that would be generated by a real object located at the same position of the reconstructed object. One can then back-transform these wavefronts to the hologram to determine how the hologram needs to be encoded to generate these wavefronts. A suitably encoded hologram can then generate a reconstruction of the three-dimensional scene that can be observed by placing one's eyes at the plane of the observer window and looking through the observer window.

A patent application PI 9812925-2 filed on Oct. 15, 1998 discloses a system for the production of a dynamic image for use in holography that includes a light source which travels via a liquid crystal modulator placed in the path of the light source . The output of the LC modulator passes modulated light through a lens array which itself guides light to an optically addressed spatial light modulator. The resulting real image from the optically addressed spatial light modulator may be used in holography. The addressing frame-rate of the liquid crystal modulator is substantially greater than the frame-rate of the optically addressed spatial light modulator.

A patent application MU 7702757-4 filed on Oct. 15, 1997 discloses a system for measuring residual stress on the surfaces of objects using as a measuring principle a combination of the blind-hole method and electronic holography. To carry out these measurements, the system has a series of subsystems with the following functions: (a) attaching firmly the object; b) shining properly the laser light on the surface; c) capturing the enlarged image of the surface being measured; d) drilling properly the measured region; e) guiding the drill; f) measuring the displacement field in the immediate vicinity of the region drilled; g) measuring optically the hole diameter; (h) keeping the alignment and rigidity between several components, and (i) obtaining and processing fringe image maps and extracting from them the data that allow calculating the values of the measured residual stress.

A patent application PI 9408175-1 filed on Nov. 28, 1994 discloses a process for producing a master hologram of a physical system and light control film assembly for use in a hologram viewing device. An apparatus for reconstructing holographic images includes a white light source, diffraction grating for generating zero-order diffracted light and at least first-order diffracted light, and light control film which is configured to block the zero-order diffracted light and to facilitate passage of a desired bandwidth of first-order diffracted light therethrough. In one embodiment light control film comprises a front layer, a core layer, and a back layer. The back layer may be thought of as a datum, whereby a lateral shift in front film results in wavelength selectively, and a corresponding shift in core layer results in good zero-order light blocking The resulting light is a pseudo-monochromatic source having sufficient coherence for use as a hologram reconstruction beam.

Finally, a patent application PI 9307547-2 filed on Nov. 26, 1993 discloses a method and apparatus for making holograms that include a technique for exposing a film substrate or other light sensitive medium to consecutive two-dimensional images, together representative of a three-dimensional system, to generate a three-dimensional hologram of the physical system. Low beam ratios are employed to superimpose multiple images on the substrate. Each image is relatively weak, but the combination of the series of weak images ultimately appears as a single clearly defined hologram.

Therefore, no other patent that has the same characteristics and innovations related to the patent proposed herein has been found.

Proposed Development

Due to the considerations related to the prior art, there is provided a development of a holographic image viewer for small and medium-sized media devices, which is an innovative device in the form of projection of the image originated on the screen of a mobile device arranged on a plane in space, allowing the image to interact with objects on the same plane and/or planes closer to or farther from the image and/or user. The possibilities of using said device are most varied, depending on the audiovisual content. Its inventive concept lies in its portability, providing viewing of holographic moving images (the 3-D ones according to the incidence of light on the image) generated by any type of video player such as a smartphone, tablet, notebook, LED and LCD monitor. As the main property of said device is its portability, it can be used individually and relies on low cost manufacturing technology.

### DESCRIPTION OF THE DRAWINGS

This utility model is characterized by means of drawings embodying a holographic image viewer for small and medium-sized media devices such that it may be reproduced by means of a proper technique, allowing full characterization of the functionality of the subject matter hereof. The description is based on the figures that show the best or preferred embodiment with detailed and consecutive numbering which clarifies the aspects that may be implied by the adopted embodiment, so as to determine clearly the extent of protection applied for hereby. These figures are merely illustrative and may vary since they do not deviate from the initially claimed principle.

FIG. 1 is a side view of the proposed utility model.

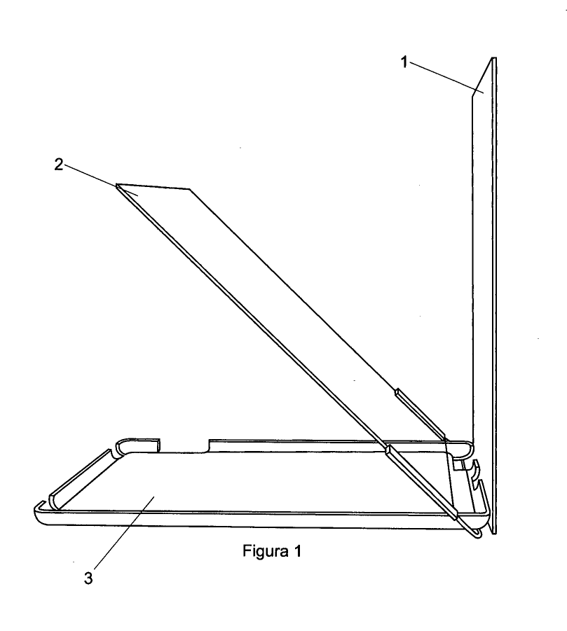

FIG. 2 is a perspective view of the proposed utility model.

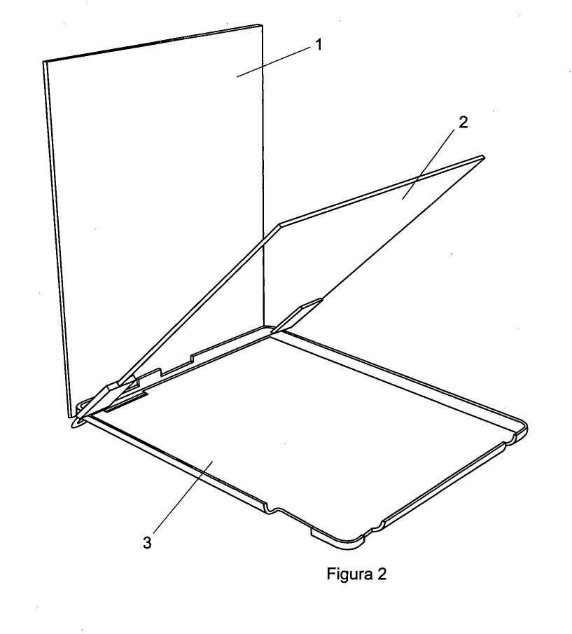

FIG. 3 is a view from above of the proposed utility model.

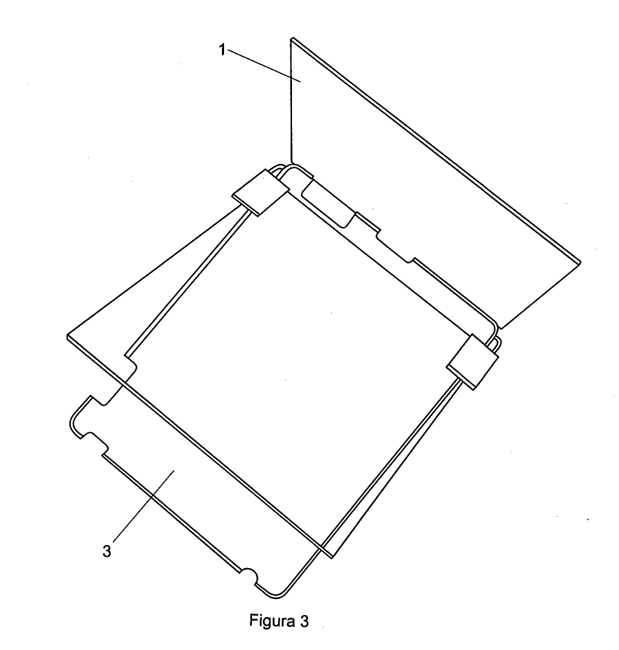

### DETAILED DESCRIPTION

A holographic image viewer for small and medium sized media devices comprises a reflection generating sheet (2), a protective cover (1), and a docking station for the mobile device (3), besides a fitting for engaging backgrounds with different contents and mechanisms. The method of operation of said holographic image viewer for small and medium sized media devices consists of forming a hologram by shining light on an object, in this case, a protective cover, thus forming what is called an object beam. An intermediary plane is chosen, in this case, a sheet onto which a uniform lateral beam is incident, which is called a reference beam because it keeps the inclination angle at which it is disposed. At this point, a high definition video to be exposed is played. There are no lenses, just the video that is exposed to the reference beam and the object beam. To view the reproduced hologram, the reference beam incident on the sheet as when the hologram is created is replaced and the image of the 3-D object will be projected. The concepts used to create the hologram are diffraction and interference when a beam ray of the object is together with the reference beam on the sheet.

What is claimed is:

1. A holographic image viewer for small and medium-sized media devices comprising a reflection generating sheet, a protection cover, and a station for docking a mobile device, in addition to a fitting for engaging backgrounds with different contents and mechanisms, said viewer being an innovative device in the form of projection of the image originated on the screen of a mobile device arranged on a plane in space, allowing the image to interact with objects on the same plane and/or planes closer to or farther from the image and/or user.

2. A holographic image viewer for small and medium-sized media devices, as in claim 1, whose inventive concept lies in its portability, providing viewing of holographic moving images (the 3-D ones according to the incidence of light on the image) generated by any type of video player such as a smartphone, tablet, notebook, LED and LCD monitor.
